(19) United States
(12) Patent Application Publication
(10) Pub. No.: US 2010/0037476 A1
(43) Pub. Date: Feb. 18, 2010

(54) Brake chamber stroke gauge

(76) Inventor: Thomas Clark Grantham, Smithville, TX (US)

Correspondence Address: Thomas Clark Grantham, 112 Felix Drive, Smithville, TX, 78957, US

(21) Appl. No.: 12/462,868

(22) Filed: Aug. 11, 2009

Related U.S. Application Data
(60) Provisional application No. 61/188,941, filed on Aug. 14, 2008.

(51) Int. Cl. G01D 21/00; B43L 7/00

(52) U.S. Cl. 33/609; 33/483

(57) ABSTRACT

This invention is a Brake Chamber Stroke Gauge. The Brake Chamber Stroke Gauge is a hand tool for the purpose of measuring brake chamber push-rod stroke on vehicle air brake systems. The Brake Chamber Stroke Gauge is comprised of a measuring rule that is connected to a bar in such a fashion as to allow the rule to travel or slide along the length of the bar, in order to position the numbering or characters at any desired location along the length of the bar. The invention has 2 sides: side A and side B. The increments and characters on side A are configured to be read in the upright position, and increasing in value when read from left to right. The increments and characters on side B are configured to be read in the upright position, and increasing in value when read from right to left.

This application claims priority to Provisional Patent Application No. 61/188,941 filed on Aug. 14, 2008

### BACKGROUND AND SUMMARY OF THE INVENTION

This invention solves problems relating to measuring brake chamber stroke. Typically, an individual faced with the task of checking chamber stroke will position a tape measure along the length of the brake chamber push-rod and select a reference point somewhere along the length of the push rod. Let's say for example, the selected reference point is indicated at 3- 5/16 inches on the measuring tape. The brakes are then applied and the reference point now travels to 4-¾ inches as indicated on the measuring tape. The user is now faced with the task of performing the mathematics involved in determining the length of stroke or travel. He/she must subtract the first measurement from the second measurement in order to determine chamber stroke. Mistakes can be made and inaccuracy can result. In addition, when the user checks chamber stroke on the other side of the vehicle, the measuring tape is now being read upside down, and there is often a different type of measurement system present on the inverted view of the measuring tape, thus creating an even more confusing situation for the user.

An object of the present invention is to solve these problems and provide a simpler method of measuring chamber stroke. The user holds the Stroke Gauge in position, parallel to the brake chamber push rod, then slides the rule along the bar so that the zero increment aligns with any chosen reference point along the length of the brake chamber push-rod. When the brakes are applied, said reference point will move to its applied position and location on the rule. The applied location on the rule will be read by the user as the amount of stroke or travel. No mathematic subtraction is required.

A further object of this invention is to eliminate the upside-down reading of a tape measure in the typical method of reading chamber stroke. When the stroke gauge is turned to side B for the purpose of measuring chamber stroke on the other side of the vehicle, the rule numbering or characters on side B of the stroke gauge will be read in the right side up position and will increase in value when read from right to left.

### BRIEF DESCRIPTION OF THE DRAWINGS

FIG. 1 is a plain view of side A of this invention.

FIG. 2 is a plain view of side B of this invention.

FIGS. 3 and 4 illustrate the present invention and the brake chamber assembly being interacted with each other under 2 conditions of use, for the purpose of demonstrating the present inventions function and purpose. The brake chamber drawing is shaded for the purpose of clearly identifying and understanding that this component is not this invention. Furthermore, the brake chamber (shaded) and the invention are clearly separate and not in contact with each other. FIG. 3 illustrates the brake chamber x on one side of the vehicle. Also illustrated by arrows, is the direction of travel of the push rod x. FIG. 4 illustrates the brake chamber x on the other side of the vehicle, and appears flipped from left to right as compared to FIG. 3.

### DETAILED DESCRIPTION OF THE PREFERRED EMBODIMENT

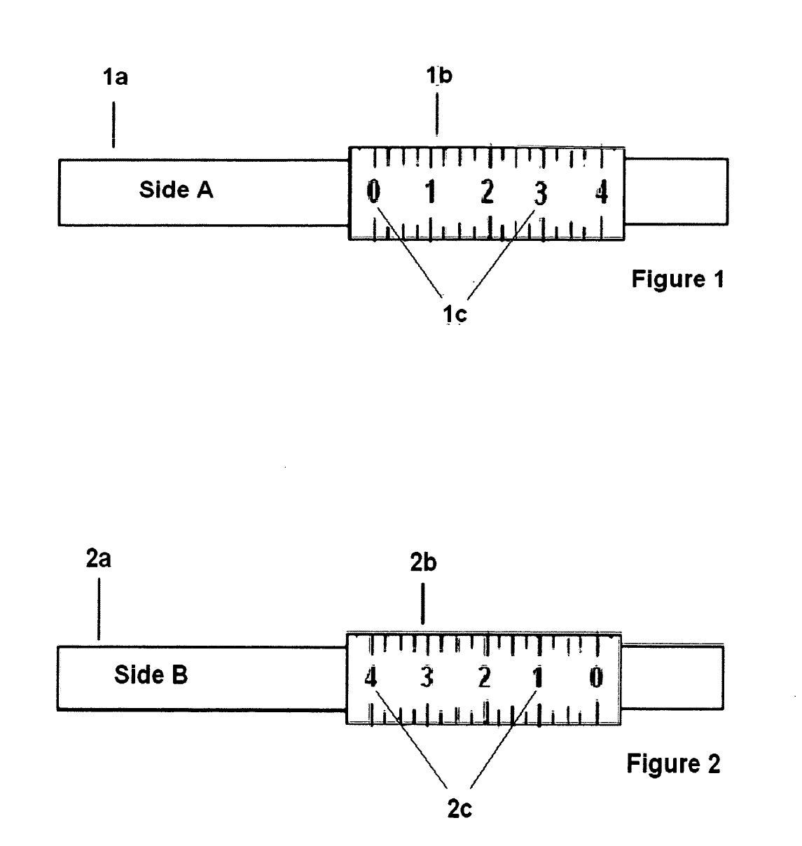

In reference to FIG. 1, the invention consists of a bar 1a and a rule 1b. The rule 1b is allowed to travel along the length of the bar 1a, allowing the characters 1c to be positioned at any desired location along the length of the bar 1a.

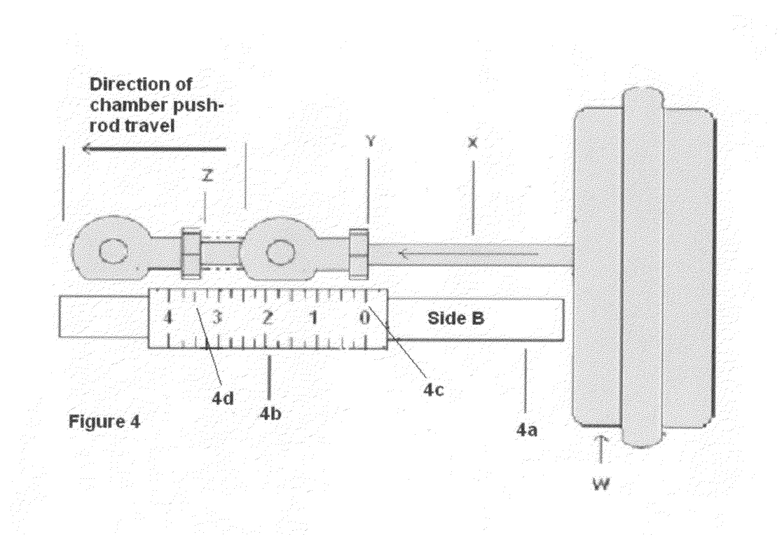

Referring to FIG. 3, the invention is positioned along the length of the push-rod x, for the purpose of measuring chamber stroke. The end of the bar 3a is placed against the chamber w. the rule 3b is moved by the user to position the zero increment 3c at the chamber push-rod nut y. When the brakes are applied, the amount of brake chamber stroke can be read by the position of the nut z, corresponding to the increment 3d. In this particular instance, the brake chamber stroke is 3-½″.

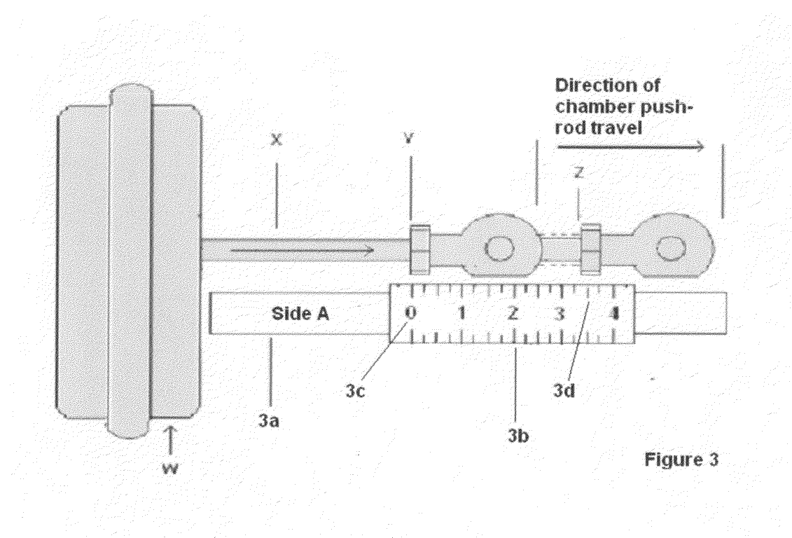

FIG. 2 is a plain view of side B of the invention. The characters 2c can still be read in the upright position, increasing in value from right to left.

Referring to FIG. 4, the chamber w is on the other side of the vehicle than previously illustrated in FIG. 3. You will note that the chamber w and its related parts view is flipped from left to right as compared to FIG. 3. The invention is now turned over to side B, and is positioned along the length of the push-rod x, for the purpose of measuring brake chamber stroke. The characters are read in the upright position, increasing in value from right to left. The rule 4b can be moved along the bar 4a in order to locate the 0 increment 4c at the trailing edge of the nut y. When the brakes are applied, the amount of brake chamber stroke can be read by the position of the nut z, corresponding to the increment 4d. In this particular instance, the brake chamber stroke is 3-½″. It may be appreciated that in this situation the characters 2c are being read in the upright position, whereas if a tape measure were used, the characters or numbers would be read in the upside-down position.

1. A tool for the purpose of measuring brake chamber stroke on a vehicle air brake system, comprising:
a measuring rule which is connected to a bar in such a fashion as to allow the measuring rule to travel or slide along the length of said bar;

2. A tool for the purpose of measuring brake chamber stroke on a vehicle air brake system, further comprising:
characters on side A of the rule which are configured to be read in the upright position, and increasing in value when read from left to right;
and increments and characters on side B of the rule which are configured to be read in the upright position, and increasing in value when read from right to left;
